(19) United States
(12) Patent Application Publication
(10) Pub. No.: US 2016/0200471 A1
(43) Pub. Date: Jul. 14, 2016

(54) Bag Holding Device

(71) Applicant: Marlin Malherek, Plymouth, MN (US)

(72) Inventor: Marlin Malherek, Plymouth, MN (US)

(21) Appl. No.: 14/940,959

(22) Filed: Nov. 13, 2015

Related U.S. Application Data
(60) Provisional application No. 62/102,185, filed on Jan. 12, 2015.

(51) Int. Cl. B65B 67/12; B65F 1/14

(52) U.S. Cl. CPC B65B 67/1238; B65F 1/1415

(57) ABSTRACT

A bag holding device for holding a bag in an open configuration to facilitate placement of objects therein. The bag holding device includes an elongated handle having a first end and a second end. A plurality of arms extends from the first and second ends of the handle, wherein each arm includes a fastener on an end thereof. Preferably, a pair of arms is positioned on each end of the handle, wherein the arms are arranged in a V-shaped configuration. The perimeter of the upper end of a bag can be secured to the fasteners on the arms so as to hold the bag in an open configuration. This allows the user to hold the handle of the bag holding device in one hand, while using the other hand to place items into the bag.

### CROSS REFERENCE TO RELATED APPLICATION

This application claims the benefit of U.S. Provisional Application No. 62/102,185 filed on Jan. 12, 2015. The above identified patent application is herein incorporated by reference in its entirety to provide continuity of disclosure.

### BACKGROUND OF THE INVENTION

### Field of the Invention

The present invention relates to bag holding devices. More specifically, the present invention provides a bag holding device for holding a bag in an open configuration to allow a user to more easily place objects into the bag.

It is often necessary for a person to place objects into a bag. A person may hold a bag when packing food into a bag, when picking up trash or animal waste, when collecting leaves or grass, among various other situations. However, it can be difficult for a user to hold a flexible bag, such as a plastic bag or a fabric bag, in an open configuration using only one hand. Generally, a person holds a bag in one hand, and picks up items with the other hand. When the user attempts to place the items into the bag, it can be difficult to insert the items into the bag due to the movement of the bag and the opening thereof. Thus, a device for holding a bag in an open configuration is desired to allow a user to more easily fill a bag with various items.

Devices have been disclosed in the prior art that relate to bag holding devices. These include devices that have been patented and published in patent application publications. These devices generally relate to bag holding devices having various constructions for holding a bag in an open position, such as U.S. Pat. No. 6,199,802, U.S. Pat. No. 7,789,441, U.S. Pat. No. 6,604,717, U.S. Published Patent Application Number 2008/0017121, and U.S. Pat. No. 7,753,322.

These prior art devices have several known drawbacks. The devices in the prior art fail to provide a handle and a plurality of arms having fasteners thereon for securing a bag thereto. This construction allows a bag to be easily secured to and removed from the device. Further, the handle allows a user to hold the bag in the open configuration in one hand while using the other hand to pick up objects and place them into the bag.

In light of the devices disclosed in the prior art, it is submitted that the present invention substantially diverges in design elements from the prior art and consequently it is clear that there is a need in the art for an improvement to existing bag holding devices. In this regard the instant invention substantially fulfills these needs.

### SUMMARY OF THE INVENTION

In view of the foregoing disadvantages inherent in the known types of bag holding devices now present in the prior art, the present invention provides a new bag holding device wherein the same can be utilized for providing convenience for the user when inserting objects into a bag without the assistance of another person.

The bag holding device comprises a handle having a first end and a second end. A plurality of arms are secured to the handle, wherein each arm has a fastener on an end thereof for removably engaging a portion of a bag. A bag can be secured to the various fasteners on the bag holding device so that the bag is held in an open configuration. This allows a user to more easily place objects into the opening of the bag.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of the bag holding device.

FIG. 2 shows a side view of the bag holding device.

FIG. 3 shows a perspective view of the bag holding device in use.

### DETAILED DESCRIPTION OF THE INVENTION

Reference is made herein to the attached drawings. Like reference numerals are used throughout the drawings to depict like or similar elements of the bag holding device. For the purposes of presenting a brief and clear description of the present invention, the preferred embodiment will be discussed as used for holding a bag in an open configuration. The figures are intended for representative purposes only and should not be considered to be limiting in any respect.

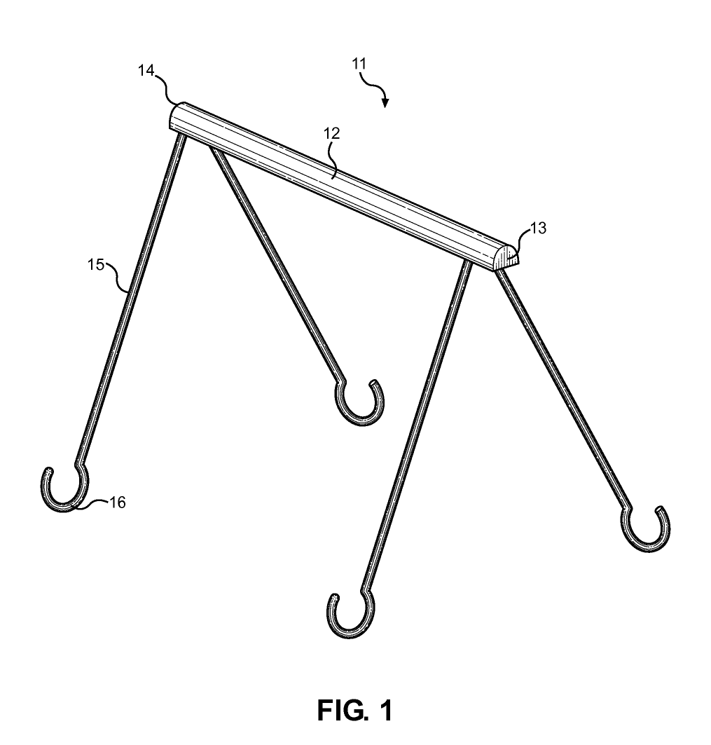

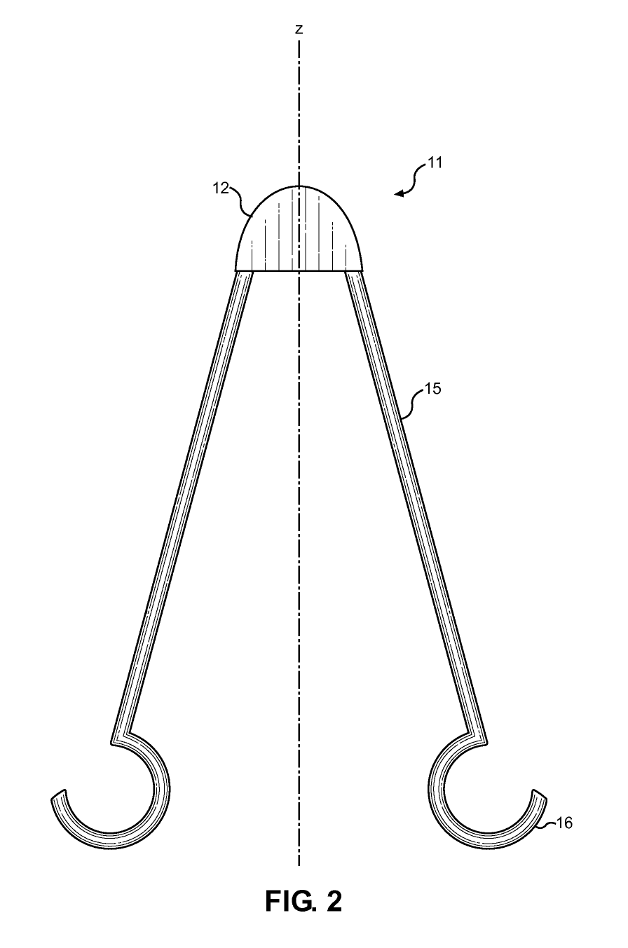

Referring now to FIGS. 1 and 2, there is shown a perspective view and a side view of the bag holding device, respectively. The bag holding device 11 comprises a handle 12 having a first end 13 and a second end 14. Preferably, the handle 12 comprises a substantially linear rod. However, in alternate embodiments, the handle 12 comprises a curved or arcuate shape. In some embodiments, the handle 12 includes padding thereon to provide a comfortable grip for the user. The handle 12 is adapted to be held by the user in a single hand.

A plurality of arms 15 extend from the handle 12, wherein each arm 15 includes a fastener 16 on an end thereof that is adapted to be removably secured to a portion of a bag. In the illustrated embodiment, a first pair of arms 15 is positioned on the first end 13 of the handle 12 and a second pair of arms 15 is positioned on the second end of the handle 12. In the illustrated embodiment, the arms 15 are substantially linear in configuration. The first pair of arms 15 is arranged in a V-shaped configuration such that each arm extends outwardly from the handle 12. Each arm 15 is preferably the same length. Preferably, the first pair of arms 15 is arranged in a single plane. The second pair of arms 15 is also arranged in a single plane.

The fasteners 16 on the arms 15 are removably securable to a portion of a bag so as to hold the bag in an open configuration. Preferably, the fasteners 16 are hooks as shown in the illustrated embodiment. However, in alternate embodiments, other fasteners 16 may be used, such as clips, clasps, and the like. The fasteners 16 allow the upper end of a bag to be easily secured thereto without damaging the bag.

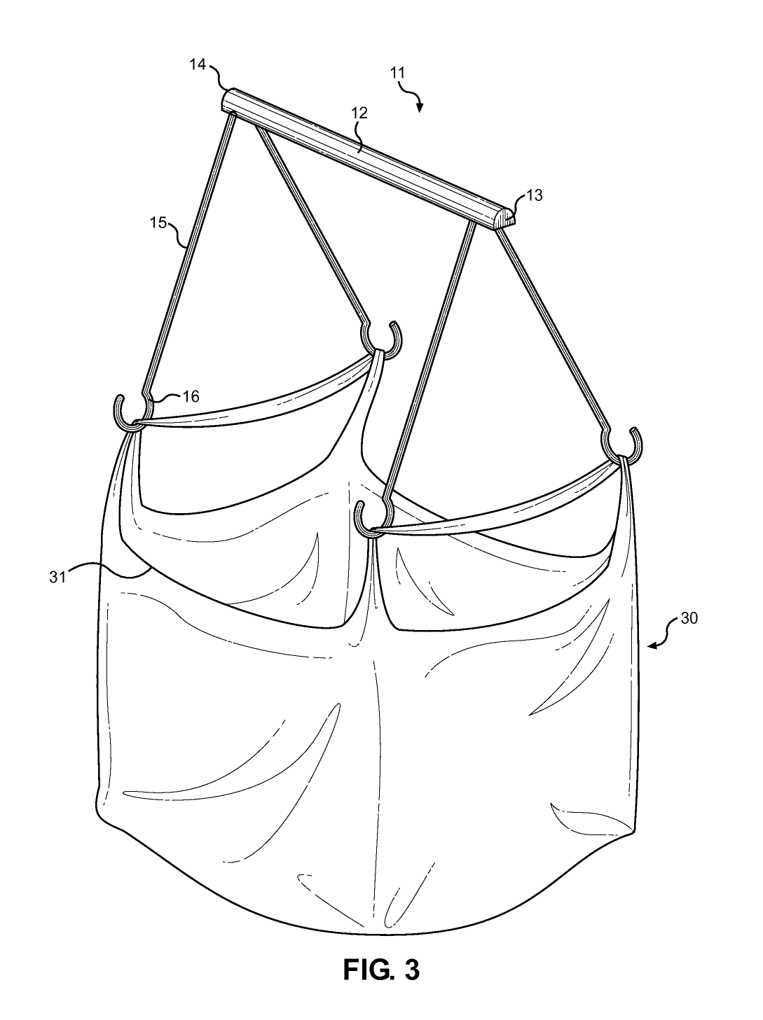

Referring now to FIG. 3, there is shown a perspective view of the bag holding device in use. In operation, a conventional bag 30 having a flexible body, such as a plastic bag or a fabric bag, can be removably secured to the bag holding device 11. The user can secure the edge or perimeter of the upper portion of the bag 30 to a fastener 16 on each arm 15. When the bag 30 is secured to the fasteners 16 on the bag holding device 11, the bag 30 is held in an open configuration and is stretched between the fasteners 16. The user can then hold the handle 12 in a first hand and can use the other hand to grasp objects for insertion into the bag 30. The bag holding device 11 securely holds the bag 30 in the open configuration so that the user will not have to struggle to hold the bag 30 open with a single hand. When the bag 30 is full, the user can disengage the fasteners 16 with the bag 30 so as to release the bag 30 from the bag holing device 11.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A bag holding device, comprising:
a handle having a first end and a second end;
a plurality of arms secured to the handle;
each of the plurality of arms having a fastener on an end thereof, wherein the fastener is used to secure a portion of a bag thereto so as to hold the bag in an open configuration.

2) The bag holding device of claim 1, wherein the plurality of arms are affixed to the first end and the second end of the handle.

3) The bag holding device of claim 1, wherein the plurality of arms comprises a pair of arms affixed to the first end of the handle and a pair of arms affixed to the second end of the handle.

4) The bag holding device of claim 3, wherein the pair of arms on the first end of the handle are coplanar.

5) The bag holding device of claim 3, wherein the pair of arms on the first end of the handle form a V-shaped configuration.

6) The bag holding device of claim 1, wherein the plurality of arms are substantially the same length.

7) The bag holding device of claim 1, wherein the fastener is a hook.

8) A bag holding device, comprising:
a handle having a first end and a second end;
a first pair of arms disposed on the first end, wherein each arm comprises a hook on an end thereof adapted to be secured to a portion of a bag;
a second pair of arms disposed on the second end, wherein each arm comprises a hook on an end thereof adapted to be secured to a portion of the bag.

9) The bag holding device of claim 8, wherein the first pair of arms is arranged in a triangular configuration.
